(19) United States
(12) Patent Application Publication
(10) Pub. No.: US 2025/0375668 A1
(43) Pub. Date: Dec. 11, 2025

(54) SYSTEM AND METHOD FOR EMERGENCY SUB SURFACE DISASTER LOCATION AND SURVIVAL

(71) Applicant: Samir Hanna Safar, Solana Beach, CA (US)

(72) Inventor: Samir Hanna Safar, Solana Beach, CA (US)

(21) Appl. No.: 18/738,402

(22) Filed: Jun. 10, 2024

(51) Int. Cl. A63B 29/02; A62B 7/02; A62B 33/00

(52) U.S. Cl. CPC A63B 29/021; A62B 7/02; A62B 33/00

(57) ABSTRACT

A sub surface terrestrial disaster safety device comprising a housing constructed from impact-resistant materials, a pressurized colored gas cylinder containing a neon-based mixture, an oxygen cylinder, an olfactory signal cylinder, and a micro controller. The micro controller includes sensors to distinguish between normal activities and disaster conditions, initiating a triggering mechanism upon detection. The triggering mechanism activates a permeation system controlling gas flow, creating a distinct surface mark for enhanced visibility to rescuers, while simultaneously providing emergency oxygen to the user. An alternative embodiment includes a communication module emitting a rescue signal with GPS coordinates. The device represents an advancement in safety technology, combining visibility enhancement, oxygen supply, and rescue signaling in a lightweight, durable design for individuals in disaster-prone environments.

### BACKGROUND

The present invention relates to the field of safety equipment for individuals exposed to subsurface terrestrial disasters, such as avalanches, earthquakes, landslides, sinkholes, and volcanic eruptions. More specifically, the invention pertains to a novel device that integrates visibility enhancement and an emergency oxygen supply system to improve the effectiveness of disaster safety gear.

Subsurface terrestrial disasters pose significant risks to individuals in affected areas. The rapid and overwhelming force of these events, such as the collapse of structures during earthquakes or burial under debris from landslides, can quickly lead to life-threatening situations, particularly when individuals become trapped beneath rubble or earth. Conventional safety equipment, such as location beacons and survival kits, while valuable, have inherent limitations that can result in critical delays during rescue operations.

Location beacons rely on rescuers conducting time-consuming search operations to locate buried individuals based on signals emitted by their devices. Survival kits, designed to provide essential supplies, lack a direct means of pinpointing the user's location. These limitations can significantly diminish the chances of survival for those trapped in the aftermath of a subsurface terrestrial disaster.

Prior art solutions have attempted to address these challenges. For example, U.S. Pat. No. 5,007,368 discloses a compressed gas-powered projection device that disperses liquid droplets to leave brightly colored marks on debris, alerting rescuers to the location of a trapped individual. However, this solution focuses solely on visibility enhancement and does not address the critical need for an emergency oxygen supply.

Another prior art reference, U.S. Pat. No. 6,220,909, describes a disaster survival system with an inflatable buoyancy body and a compressed gas unit. While this system aims to protect the user during a disaster event, it lacks the integration of visibility enhancement and does not provide a direct oxygen supply to the user.

U.S. Pat. No. 4,094,267 discloses a distress signal device in the form of a balloon with the word “HELP” printed on it. Although this device serves as a visual alert, it does not address the need for an integrated oxygen supply or the challenges of locating a buried individual in a subsurface disaster scenario.

The present invention addresses the limitations of the prior art by introducing a comprehensive subsurface terrestrial disaster safety device that combines visibility enhancement, an emergency oxygen supply system, and an olfactory tracking system. Furthermore, the present invention represents a significant advancement in subsurface terrestrial disaster safety technology, addressing the pressing need for a device that enhances visibility, provides emergency oxygen, incorporates and olfactory location mechanism, and improves the efficiency of rescue operations. By integrating these critical features into a lightweight, unobtrusive design, the invention offers a comprehensive solution that prioritizes user safety and survival in environments prone to subsurface terrestrial disasters.

### SUMMARY

The present invention relates to an advanced sub surface terrestrial disaster safety device designed to enhance the safety of individuals in environments prone to avalanches, earthquakes, landslides, sinkholes, and volcanic eruptions. The device comprises a housing constructed from lightweight, impact-resistant materials such as high-density polyethylene (HDPE), carbon fibers, or thermoplastic polyurethane (TPU). The housing is securely attached to the user's clothing or gear, ensuring constant accessibility, and minimizing the risk of separation from crucial safety equipment.

The device also includes an oxygen cylinder connected to an output valve, positioned in the lower region of the housing. The oxygen cylinder is configured to supply emergency oxygen to the user, with the output valve being automatically activated by the micro controller in emergencies or manually triggered by the user. Additionally, the device includes an ethyl mercaptan cylinder to emit an odor to provide olfactory-based location tracking via rescue animals.

The micro controller, integrated into the housing, comprises sensors such as accelerometers, pressure sensors, and seismic sensors to distinguish between normal activities and sub surface terrestrial disaster conditions. The circuitry operates on a rechargeable battery with a USB-C port for recharging and external monitoring. Upon detecting disaster conditions, the micro controller initiates a triggering mechanism that includes a 10-second countdown to avoid false activations. During the countdown, the circuitry continuously assesses data from the sensors to confirm the persistence of abnormal conditions before releasing the colored gas. The triggering mechanism activates the permeation system, which is connected to the colored gas cylinder and controls the gas flow through an opening valve. This ensures a steady ascent of the gas through the compacted debris, creating a distinct mark on the surface for enhanced visibility to rescuers. Simultaneously, the oxygen valve opens, providing the user with a controlled emergency oxygen supply and the ethyl mercaptan valve also opens to begin emitting an olfactory signal for rescue animals.

In an alternative embodiment, the device includes a communication module integrated with the micro controller, which emits a rescue signal containing GPS coordinates upon disaster detection. This feature aids rescue teams in swiftly locating and extracting individuals from disaster debris.

The sub surface terrestrial disaster safety device of the present invention represents a significant advancement in safety technology, seamlessly combining visibility enhancement, controlled oxygen supply, and reliable rescue signaling in a lightweight, unobtrusive design. Its secure attachment to the user's clothing or gear, use of environmentally friendly gases, and durability in extreme conditions make it an indispensable tool for individuals in areas prone to avalanches, earthquakes, landslides, sinkholes, and volcanic eruptions. By prioritizing swift detection, accurate rescue signaling, and enhanced survival capabilities, the device provides a comprehensive safety solution for individuals in sub surface terrestrial disaster-prone environments.

### BRIEF DESCRIPTION OF THE DRAWINGS

The various exemplary embodiments of the present invention. which will become more apparent as the description proceeds, are described in the following detailed description in conjunction with the accompanying drawings, in which:

FIG. 1 illustrates an embodiment of the sub surface disaster safety device securely attached to the strap of a set of goggles.

FIG. 2 illustrates an overview of the system architecture, depicting the components and their interactions.

FIG. 3 presents a flowchart illustrating the operation of the sub surface disaster safety system.

FIG. 4 illustrates the 5V solenoid valve within the device.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein. each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might.” or “may.” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

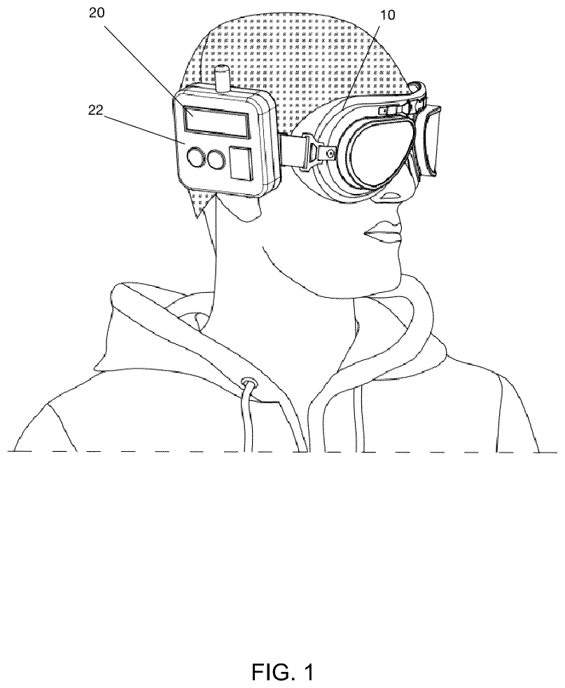

FIG. 1 illustrates an embodiment of the sub surface disaster safety device 20 securely attached to the strap of a set of goggles 10 via a clip, ensuring constant readiness and reducing the risk of separation from this essential safety equipment. The avalanche safety device 20 is technologically advanced apparatus aimed at enhancing the safety of winter sports enthusiasts and mountaineers facing avalanche-prone terrains.

The housing 22 of the device 20, constructed from lightweight and impact-resistant materials such as high-density polyethylene (HDPE), carbon fibers, or thermoplastic polyurethane (TPU), encases key components.

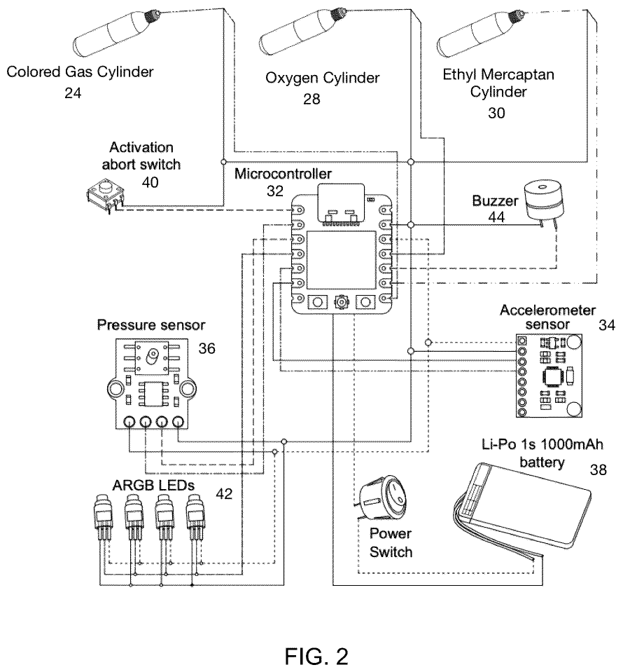

FIG. 2 illustrates an overview of the system architecture, depicting the components and their interactions within the sub surface disaster safety device 20. The device 20 comprises a housing 22 that securely contains a pressurized colored gas cylinder 24, an oxygen cylinder 28, an ethyl mercaptan cylinder 30, a micro controller 32, and various sensors and modules.

The pressurized colored gas cylinder 24, filled with a neon-based mixture having a lighter-than-air density, is equipped with a refillable or replaceable cartridge and an inlet valve for convenient maintenance. The neon-based mixture may be selected from colors comprising fluorescent orange, fluorescent pink, or fluorescent lime green to provide vivid visibility. When released during an emergency, the colored gas permeates upwards through compacted debris above the user, creating a visible mark on the snow surface even in low-light conditions, aiding rescuers in locating buried individuals.

A pressurized cylinder of ethyl mercaptan 30 is included as an odorant component. Ethyl Mercaptan has a strong, distinct odor detectable by humans and animals at very low concentrations, making it effective for olfactory location tracking for rescue animals. The ethyl mercaptan 30 is connected to an output valve (not shown)

The oxygen cylinder 28 is connected to an output valve (not shown), which can be opened automatically in an emergency or manually triggered by the user to supply emergency oxygen during a sub surface emergency disaster scenario.

A permeation system (not shown), connected to the pressurized colored gas cylinder 24, controls the flow of gas for a steady ascent through the snow. An opening valve (not shown) within the permeation system regulates the gas flow, ensuring precise deployment.

The device 20 incorporates a micro controller 32 that interfaces with a plurality of sensors, including an accelerometer 34 and pressure sensor 36. These sensors are configured to detect abnormal conditions indicative of an avalanche or earthquake scenario, distinguishing between normal activities and hazardous situations.

The Inertial Measurement Unit (IMU) (not shown) described herein comprises a integrated assembly connected to multiple accelerometers and gyroscopes configured to accurately measure and report the linear acceleration and angular velocity of an object across three orthogonal axes. The accelerometers detect acceleration forces, allowing the calculation of motion, speed, and position, while the gyroscopes provide precise measurements of rotational movements. The synergistic operation of these sensors permits the IMU to deliver comprehensive navigational data essential for inertial navigation systems.

A rechargeable LI-PO battery 38 powers the micro controller 32, and a USB-C port (not shown) allows for convenient recharging and external monitoring of the system's functions.

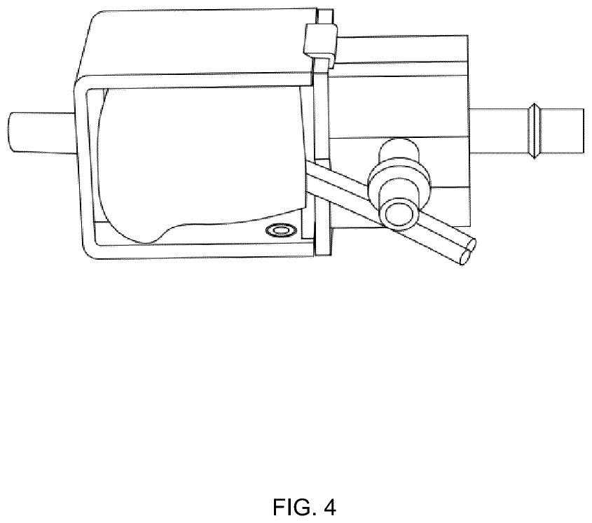

The triggering mechanism, initiated by the micro controller 32 upon disaster detection, includes a 10-second countdown to prevent false activations. During this time, the user can hit the activation abort switch 40 to stop the execution of the process. Upon confirmation of avalanche or earthquake conditions, the triggering mechanism releases the colored gas, creating a visible mark on the surface. Simultaneously, the oxygen valve and the ethyl mercaptan valve open to supply emergency oxygen to the user and release the olfactory signal. The valves (not shown) are engineered to prevent clogging by snow, ice, or debris. Example valve shown in FIG. 4.

The device 20 also includes a manual push-button (not shown) connected to the microcontroller 32 for externally activating the triggering mechanism when needed. In case of avalanche or earthquake detection, a communication module (not shown) integrated with the microcontroller 32 emits a rescue signal containing vital GPS coordinates, aiding swift location and extraction by rescue teams.

To further enhance the device's functionality, a color-coded LED light system 42 is integrated into the housing 22. The LED lights are strategically positioned around the device, visible from all angles, and are directed towards the front of the user's head (face). Each LED color corresponds to a different orientation: green for upward (towards the surface), red for downward (deeper), and blue for sideways (left or right). The micro controller 32 utilizes data from the accelerometer 34 and gyroscope (not shown) to determine the device's (and thus the wearer's) orientation relative to the ground, detecting tilts, rotations, and absolute positioning. The LEDs activate automatically upon detecting a sub surface disaster scenario, illuminating the corresponding color based on the device's current orientation to indicate the most likely direction toward the surface. This feature assists rescuers in determining the position of the buried individual more accurately and quickly.

Additionally, the device 20 includes a speaker or buzzer 44, controlled by the micro controller 32, for emitting auditory signals when manual activation is needed or when alerts must be given.

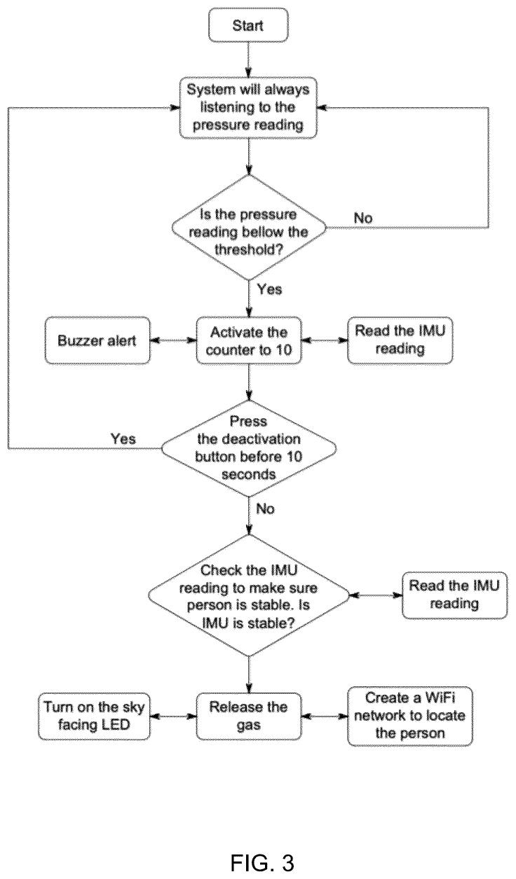

FIG. 3 presents a flowchart illustrating the operation of the sub surface disaster safety system. The process begins with the wearer securely attaching the system housing to their goggle strap and powering on the device using the On/Off switch. Upon start up, the system performs power-on self-check procedures, including monitoring the battery level using LED lights. If the battery is low, the corresponding LED will blink in red color.

In the standby monitoring mode, the pressure sensor and IMU actively monitor for abnormal sub surface disaster conditions by comparing sensor readings to predefined threshold values based on research documents. The main triggering criteria is a drop in pressure sensor reading below the threshold.

If potential sub surface disaster conditions are detected, a 10-second countdown is initiated, accompanied by a buzzer sound to alert the wearer and allow confirmation of the hazardous state while preventing false triggers. The wearer can press a button to reset the system if they are not in danger.

If sub surface disaster conditions persist after the countdown, the system checks the gyroscope reading from the IMU to ensure the wearer has fallen and is stable in location before activating the rescue sequence. This involves opening the pressurized cylinder valves to release the oxygen, ethyl mercaptan and the high-visibility neon gas marker, allowing 30 seconds for potential self-rescue.

The colored gases create a visible beacon on the snow surface to guide rescuers to the victim's location. The system also starts a low-power Wi-Fi network to enable rescuers to locate the missing person's signal. LEDs oriented upward to the sky are turned on for additional visibility.

After the gas release, the system opens the oxygen cylinder output valve to provide an emergency air supply. The system remains active, providing oxygen and visual marking until the wearer is rescued or the system is manually deactivated after recovery. The system then returns to standby mode, ready for future use.

The sub surface disaster safety system is powered by a rechargeable battery integrated into the housing. The battery utilizes a standard USB-C port for convenient recharging and can interface with external devices to monitor system status and functionality.

By providing an automated, self-contained sub surface disaster safety device with high-visibility marking, emergency oxygen supply, rescue signaling capability via multiple modalities, and Wi-Fi localization, this invention significantly enhances the survivability of sub surface disaster victims and facilitates rapid rescue and recovery efforts.

FIG. 4 illustrates the 5V solenoid valve within the safety device, integral for activating pressurized cylinders of ethyl mercaptan, neon-based visibility gas, and oxygen. Operated by signals from the microcontroller upon detecting sub surface disaster conditions, this valve ensures the controlled release of essential gases. Designed to be compact and efficient, the valve mechanism is engineered to prevent clogging by snow, ice, or debris, maintaining reliable functionality in extreme conditions.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A method for enhancing sub surface disaster rescue, the method comprising:
securely attaching a housing constructed from impact-resistant materials to a user; providing within said housing a pressurized colored gas cylinder containing a neon-based mixture having a lighter-than-air density, wherein said cylinder is equipped with a refillable or replaceable cartridge and an inlet valve; detecting, via a micro controller integrated into the housing and comprising a plurality of sensors comprising an accelerometer, a gyroscope and a pressure sensor, abnormal conditions indicative of a sub surface disaster scenario; initiating, by the micro controller, a triggering mechanism in response to said detected abnormal conditions, said triggering mechanism configured to release the colored gas from the pressurized colored gas cylinder; controlling, via a permeation system connected to the pressurized colored gas cylinder and comprising an opening valve, the flow of the colored gas to ensure a steady ascent through compacted snow; and
creating a visible mark on a snow surface by the released colored gas for enhanced visibility to rescuers.

2. The method of claim 1, wherein the housing is constructed from materials selected from the group consisting of high-density polyethylene (HDPE), carbon fiber, and thermoplastic polyurethane (TPU).

3. The method of claim 1, wherein the pressurized colored gas cylinder contains a neon-based mixture with colors comprising fluorescent orange, fluorescent pink, and fluorescent lime green.

4. The method of claim 1, further comprising providing an oxygen cylinder within the housing, the oxygen cylinder connected to an output valve configured to supply emergency oxygen to a user.

5. The method of claim 4, wherein the output valve is automatically opened by the micro controller in response to the detected abnormal conditions.

6. The method of claim 4, wherein the output valve is manually opened by the user via a manual push-button.

7. The method of claim 1, wherein the micro controller further comprises a rechargeable battery and a USB-C port for recharging the battery and enabling external monitoring.

8. The method of claim 1, wherein the triggering mechanism comprises a 10-second countdown initiated by the micro controller to prevent false activations.

9. The method of claim 8, wherein the micro controller continuously assesses data from the plurality of sensors during the 10-second countdown to confirm the abnormal conditions persist before releasing the colored gas.

10. The method of claim 1, further comprising emitting a rescue signal containing GPS coordinates by a communication module integrated with the micro controller upon detecting the abnormal conditions.

11. The method of claim 1, wherein the colored gas is non-toxic and the pressurized colored gas cylinder is refillable or replaceable.

12. The method of claim 1, wherein the opening valve in the permeation system is configured to prevent clogging by snow or ice.

13. The method of claim 1, further comprising allowing a 30-second delay for a user to self-rescue after detecting the abnormal conditions and before automatically opening the output valve to supply emergency oxygen.

14. The method of claim 1, wherein the housing is securely attached to the user via placements comprising the strap of a user's goggles, the belt of the user's waist.

15. The method of claim 1, wherein the micro controller enters a standby state for future use after a user is rescued or the device is deactivated following usage.

16. The method of claim 1, wherein a cylinder of gas is released emitting an odor to facilitate olfactory based location tracking.

17. The method of claim 1, further comprising providing a cylinder containing a gas for olfactory location tracking, the cylinder containing a gas for olfactory location tracking connected to an output valve to release the gas for olfactory location tracking.

18. A sub surface disaster rescue and safety system comprising:
a housing constructed from impact-resistant materials and configured to be securely attached to a user;
a pressurized colored gas cylinder disposed within the housing, said cylinder containing a neon-based mixture having a lighter-than-air density and being equipped with a refillable or replaceable cartridge and an inlet valve;
an oxygen cylinder positioned within the housing and connected to an output valve, said oxygen cylinder configured to supply emergency oxygen to a wearer during a sub surface disaster emergency;
a micro controller integrated into the housing, said micro controller comprising a plurality of sensors comprising an accelerometer, a pressure sensor, and a gyroscope configured to detect abnormal conditions indicative of a sub surface disaster scenario, and further configured to initiate a triggering mechanism in response to said detected abnormal conditions;
a permeation system connected to the pressurized colored gas cylinder, said permeation system comprising an opening valve to control the flow of the colored gas and ensure a steady ascent through compacted snow; and
a rechargeable battery integrated into the housing to power the micro controller, said battery equipped with a USB-C port for recharging and external monitoring of the system's functions.

19. The sub surface disaster safety system of claim 18, wherein the housing is constructed from materials selected from the group consisting of high-density polyethylene (HDPE), carbon fiber, and thermoplastic polyurethane (TPU).

20. The sub surface disaster safety system of claim 18, wherein the pressurized colored gas cylinder contains a neon-based mixture selected from the group comprising fluorescent orange, fluorescent pink, and fluorescent lime green.

21-31. (canceled)
